(19) United States
(12) Patent Application Publication
(10) Pub. No.: US 2025/0097897 A1
(43) Pub. Date: Mar. 20, 2025

(54) ULTRA-WIDEBAND POSITIONING METHOD FOR A POSITIONING DEVICE ARRANGED IN A MOTOR VEHICLE, A POSITIONING DEVICE AND A MOTOR VEHICLE HAVING SAME

(71) Applicant: MERCEDES-BENZ GROUP AG, Stuttgart (DE)

(72) Inventor: Özgür MUTLU, Stuttgart (DE)

(21) Appl. No.: 18/729,581

(22) PCT Filed: Dec. 5, 2022
(86) PCT No.: PCT/EP2022/084371

§ 371 Date: Jul. 17, 2024

(30) Foreign Application Priority Data
Jan. 18, 2022 (DE) 10 2022 000 182.9

(51) Int. Cl. H04W 64/00; H04B 1/7163

(52) U.S. Cl. CPC H04W 64/006; H04B 1/7163

(57) ABSTRACT

An ultra-wideband positioning involves a positioning device establishing a bidirectional ultra-wideband data communication between the positioning device and at least one ultra-wideband communication-enabled object approaching the motor vehicle. First positions and trajectories of the at least one object relative to the motor vehicle are determined by the positioning device using data packets exchanged in the context of the ultra-wideband data communication. Subsequently an ultra-wideband positioning and distance measurement are performed by the positioning device. Second positions and trajectories of the at least one object relative to the motor vehicle are determined by the positioning device emitting at least one ultra-wideband transmission signal and detecting its backscattered radio signals reflected back from at least one object with a time delay.

### BACKGROUND AND SUMMARY OF THE INVENTION

Exemplary embodiments of the invention relate to an ultra-wideband positioning method for a positioning device arranged in a motor vehicle, a positioning device for performing the ultra-wideband positioning method, and a motor vehicle having such a positioning device.

Ultra-wideband positioning methods are described in DE 10 2017 121 582 A1 and DE 10 2020 114 277 A1. In DE 10 2017 121 582 A1, data packets sent by ultra-wideband radio modules are used as part of ultra-wideband data communication for determining positions of an object moving relative to a station. By contrast, DE 10 2020 114 277 A1 describes the use of an ultra-wideband positioning and distance measurement, a so-called ultra-wideband radio radar, for determining positions of an object moving relative to a station. The disadvantage of the known methods for determining positions of an approaching object is that they are relatively inaccurate.

Additional ultra-wideband positioning methods are known from DE 10 2016 217 532 A1 and DE 10 2015 109 468 A1. An ultra-wideband positioning method of the type mentioned in the introduction is described in WO 2017/139432 A1.

Exemplary embodiments of the invention are directed to an improved or at least another embodiment for an ultra-wideband positioning method. In particular, an attempt will be made to specify an ultra-wideband positioning method that is relatively accurate compared to the known methods.

The basic idea of the invention is to combine the determination of an object's position based on ultra-wideband data communication with the determination of an object's position based on ultra-wideband positioning and distance measurement (ultra-wideband radio radar) in a joint method to improve the accuracy of determining positions of the object moving relative to a station.

Accordingly, an ultra-wideband positioning method is proposed for a positioning device arranged in a motor vehicle, which is characterized by the following steps, namely 1) establishing, by means of the positioning device, a bidirectional ultra-wideband data communication, in particular based on the ultra-wideband radio standard (ultra-wideband communication protocol aka Car Connectivity Consortium), between the positioning device and at least one ultra-wideband communication-enabled object approaching the motor vehicle. Here, first positions and/or trajectories of the at least one object relative to the motor vehicle are determined by means of the positioning device using data packets exchanged in the context of the established ultra-wideband data communication, in particular between the at least one object and the positioning device. Furthermore, 2) an ultra-wideband positioning and distance measurement, in particular a so-called ultra-wideband radio radar, is performed by means of the positioning device, wherein second positions and/or trajectories of the at least one object relative to the motor vehicle are determined by means of the positioning device, by the positioning device emitting at least one ultra-wideband transmission signal and detecting its backscattered radio signals reflected back from at least one object with a time delay.

Accordingly, the ultra-wideband positioning method according to the invention is a fusion of two positioning and distance measurement methods for determining positions and/or trajectories of an object approaching the motor vehicle, namely the combination of ultra-wideband data communication and ultra-wideband positioning and distance measurement (so-called ultra-wideband radio radar). This allows their respective method-related advantages to be used optimally. In particular, this has the advantage that the accuracy of determining the positions and/or trajectories of the at least one object relative to the motor vehicle, or relative to the positioning device, is clearly improved over the previously achievable accuracies of conventional positioning and distance measurement methods. This allows, for example, system functions of the motor vehicle to be activated in a targeted manner with a long lead time, whereby in particular the convenience for a user of the motor vehicle is increased.

The invention expediently understands the term ‘ultra-wideband’ and the prefix ‘ultra-wideband’ to mean a radio technology whose radio signals can be used for different purposes in a given frequency spectrum with a relatively large bandwidth of at least 500 MHz, for example. A first application of this ultra-wideband radio technology can preferably be to establish a bidirectional data communication, here referred to as an ultra-wideband data communication, between two ultra-wideband communication-enabled communication partners for exchanging data, in particular data packets. According to a further application of this ultra-wideband radio technology, a positioning and distance measurement can be provided by emitting ultra-wideband transmission radio signals and then detecting their reflected backscattered signals with a time delay. In practice, this is also referred to as ultra-wideband-based ultra-wideband radar.

Expediently, first positions and/or second positions of the at least one object together with associated trajectories are determined in the context of the ultra-wideband positioning method. The invention expediently understands the term ‘trajectories’ in the sense of a predicted movement path curve of the at least one object in first positions and/or in second positions of the at least one object. According to the invention, it is provided that the trajectories are determined by means of the positioning device using the determined first positions and/or second positions. According to the invention, a future position of the at least one object is predicted relatively accurately with the aid of the first positions and/or second positions and the associated trajectories. According to the invention, a computing unit of the positioning device, described below, is used for determining said trajectories.

Expediently, it is provided that the ultra-wideband positioning method is performed in two steps, in particular by the positioning device initially establishing a bidirectional ultra-wideband data communication and then subsequently, and in particular additionally, by the positioning device performing an ultra-wideband positioning and distance measurement. In particular, initially relatively rough first positions of the at least one object are determined in the context of the ultra-wideband data communication, i.e., rough positioning of the at least one object is realized. In particular, relatively accurate second positions of the at least one object are determined during the ultra-wideband positioning and distance measurement, so that one can also speak of pinpointing the at least one object. Therefore, the method-related advantages of the ultra-wideband data communication and the ultra-wideband positioning and distance measurement (ultra-wideband radio radar) can be used in a targeted manner so that the accuracy achievable in the context of the proposed ultra-wideband positioning method, with which the first positions and second positions of the at least one object can be determined, is optimized.

More expediently, it can be provided in the context of the ultra-wideband positioning method that the ultra-wideband data communication is established between the positioning device and the at least one object once the latter is located inside a specified or specifiable communication range of the positioning device. The communication range expediently describes a distance specified in terms of radio technology by the positioning device and the at least one object, within which an ultra-wideband data communication can be established. The distance can be set, for example, by specifying a transmission power of the positioning device and/or of the at least one object. By means of the procedure proposed above, ultra-wideband data communication between the positioning device and an object approaching the positioning device or the motor vehicle is established as early as possible, so that there is still a relatively large distance between the at least one object and the motor vehicle when the ultra-wideband data communication is established. This has the advantage that for determining further positions of the at least one object and for further actions, for example the activation of system functions of the motor vehicle, a relatively long time period remains.

According to the invention, it is provided that the second positions and/or trajectories of the at least one object relative to the motor vehicle are determined once the at least one object falls below a specified or specifiable distance between itself and the motor vehicle, which describes an approach zone surrounding the motor vehicle. Additionally, or alternatively, it can be provided that the second positions and/or trajectories of the at least one object relative to the motor vehicle are determined when the at least one object corresponds to this distance. Therefore, relatively accurate second positions of the at least one object are determined, at least inside of a specifiable approach zone around the motor vehicle, during the ultra-wideband positioning and distance measurement. Said distance can expediently be set by specifying a radar transmission power of the positioning device.

Expediently, the ultra-wideband positioning method is characterized in that to determine the first positions and/or trajectories of the at least one object relative to the motor vehicle, the data packets exchanged are evaluated by means of a transit time measurement, referred to as a TOF (time of flight), in the context of which transit times of data packets between the at least one object and the positioning device are determined. Therefore, a preferred method, based on a bidirectional data exchange, is specified for determining the first positions of the at least one object. Furthermore, it can be provided that alternatively or additionally to determining the first positions and/or trajectories of the at least one object relative to the motor vehicle, the exchanged data packets are evaluated by means of triangulation. Therefore, a preferred second method, based on data exchange, is specified for determining the first positions of the at least one object. It is understood that other methods based on data exchange can also be used to determine the first positions without leaving the scope of the invention.

Expediently, it is provided that the at least one object is realized by an ultra-wideband communication-enabled mobile unit. In particular, it can be provided that the mobile unit is realized by a mobile end device, for example by a so-called intelligent key (smart key), a mobile telephone (smart phone), or a so-called CoD, i.e., a smart device in the possession of the user of the motor vehicle (consumer owned smart device). Therefore, an embodiment for the at least one object, which is convenient for the user of the motor vehicle and widely accepted, is specified.

It is further expedient if the determination of the first positions and/or trajectories of the at least one object and the second positions and/or trajectories of the at least one object is realized by a computing unit of the positioning device, arranged in the motor vehicle, or an external computing unit, connected or connectable to the motor vehicle via radio. The computing unit forms an expediently central computing unit of the motor vehicle or at least one component of the same, for example it may be a control device. The computing unit is further expediently set up to perform the ultra-wideband positioning method.

Expediently, it is provided that the positioning device is provided with ultra-wideband transmission and receiving units installed in the motor vehicle. These ultra-wideband transmission and receiving units are respectively set up to be operated in a first operating mode, in which a bidirectional ultra-wideband data communication, in particular based on the ultra-wideband radio standard, can be established, and in a second operating mode, in which an ultra-wideband positioning and distance measurement, based in particular on ultra-wideband, can be performed. By providing ultra-wideband transmission and receiving units, an area surrounding the motor vehicle, in particular said approach zone, can be monitored efficiently and relatively quickly for approaching objects.

It is also expedient if the ultra-wideband transmission and receiving units are each operated either in the first operating mode or in the second operating mode, depending on the determined positions of the at least one object. Furthermore, it can be provided that all ultra-wideband transmission and receiving units are operated simultaneously or at least one ultra-wideband transmission and receiving unit is operated at the beginning of the ultra-wideband positioning method in the first operating mode. Furthermore, all ultra-wideband transmission and receiving units can be operated simultaneously or at least one ultra-wideband transmission and receiving unit can be operated in the first operating mode if an ultra-wideband data communication is or can be established between at least one of these ultra-wideband transmission and receiving units and at least one object located in a specified or specifiable communication range of the positioning device.

Furthermore, at least one ultra-wideband transmission and receiving unit can be operated in the second operating mode if at least one object falls below a specified or specifiable distance between this at least one ultra-wideband transmission and receiving unit and the at least one object, which describes an approach zone that surrounds the motor vehicle. Expediently, at least one ultra-wideband transmission and receiving unit is operated in the second operating mode if at least one object is located in close proximity to this ultra-wideband transmission and receiving unit. In particular, as a result the ultra-wideband transmission and receiving units operate simultaneously in the first operating mode at the beginning of the ultra-wideband positioning method in order to establish ultra-wideband data communication between themselves and at least one object located within communication range of the positioning device, wherein, when such ultra-wideband data communication has been established, the or those ultra-wideband transmission and receiving units in relation to which the at least one object falls below a specified or specifiable distance are operated in the second operating mode. In this way, a switchover time at which the ultra-wideband transmission and receiving units switch from the first operating mode to the second operating mode can be realized by simple means, so to speak.

It is further expedient if the positioning device or at least one ultra-wideband transmission and receiving unit of the positioning device is operated in pulsed mode. The positioning device or the at least one ultra-wideband transmission and receiving unit is therefore expediently provided with a transmission device set up to emit pulsed ultra-wideband transmission radio signals, which is set up to emit pulse ultra-wideband transmission radio signals that are only a few nanoseconds long. Furthermore, the positioning device or the at least one ultra-wideband transmission and receiving unit is provided with a receiving device set up to receive backscattered radio signals, which expediently is set up to detect pulse backscattered signals of the previously emitted pulse ultra-wideband transmission radio signals. The ultra-wideband transmission and receiving unit realizes thus in particular a type of ultra-wideband radar unit. This has the advantage that the first and/or second positions of the at least one object can be determined relatively accurately.

Expediently, it can be provided that in the context of the ultra-wideband positioning method, an access system arranged in the motor vehicle and connected in a communicative manner to the positioning device is controlled for locking and unlocking and/or for actively opening a vehicle door of the motor vehicle by means of the positioning device, depending on the determined first positions and/or trajectories and/or second positions and/or trajectories of the at least one object. Therefore, a position of at least one object relative to the motor vehicle can be determined by means of the ultra-wideband positioning method, and depending on the same, a vehicle door of the motor vehicle can be locked or unlocked or actively opened, for example.

A positioning device is further proposed having at least one ultra-wideband transmission and receiving unit, a computing unit, and a computer-readable storage medium, wherein the latter comprises instructions which, when performed by the computing unit, cause the positioning device to perform the ultra-wideband positioning method according to the preceding description. This provides a preferred embodiment for a positioning device for performing the ultra-wideband positioning method. The positioning device can, in particular, be installed in motor vehicles, so that the ultra-wideband positioning method can be performed therein. The installation is, however, not only limited to motor vehicles; instead, the proposed positioning device can be used in further mobile applications, such as in rail-based vehicles, aircraft, ships but also in stationary applications in buildings.

The positioning device is expediently characterized in that the at least one ultra-wideband transmission and receiving unit is equipped with a transmission device and a receiving device. The transmission device is expediently set up to emit ultra-wideband transmission radio signals. The receiving device is expediently set up to detect backscattered radio signals of the previously emitted ultra-wideband transmission radio signals and/or backscattered radio signals of at least one object with a time delay. The positioning device or the at least one ultra-wideband transmission and receiving unit thus expediently realizes an ultra-wideband communication unit as well as an ultra-wideband radar unit. Therefore, an advantageous embodiment for ultra-wideband transmission and receiving units is provided.

The positioning device or the at least one ultra-wideband transmission and receiving unit can expediently be provided with a pulse transmission device set up to emit pulsed ultra-wideband transmission radio signals. The pulse transmission device is expediently set up to only emit pulse ultra-wideband transmission radio signals that are only a few nanoseconds long. Furthermore, the positioning device or the at least one ultra-wideband transmission and receiving unit can be provided with a pulse receiving device set up to receive pulsed ultra-wideband transmission radio signals, which expediently is set up to detect pulse backscattered radio signals of the previously emitted pulse ultra-wideband transmission radio signals and/or radio answering signals of at least one object with a time delay. The ultra-wideband transmission and receiving unit expediently realizes a type of combined ultra-wideband communication unit and pulse ultra-wideband radar unit. This has the advantage that the first and/or second positions of the at least one object can be determined relatively accurately.

The positioning device or the ultra-wideband transmission and receiving units of the positioning device are expediently equipped with and/or connected in a communicative manner to an internal system clock and/or pulse wave generator and/or radio signal amplifier and/or a wave delay detector, in addition to the transmission and receiving devices explained above.

To solve the object mentioned in the introduction, a motor vehicle is also proposed that has a positioning device as described above, at least one ultra-wideband transmission and receiving unit of which is fixed in place on the motor vehicle. The motor vehicle further has an access system for locking and unlocking and/or for actively opening at least one vehicle door and/or a hood of the motor vehicle. The positioning device is connected to the access system in a communicative manner and is set up to actuate the access system depending on determined first positions and/or trajectories and/or second positions and/or trajectories of the at least one object. This allows a vehicle door of the motor vehicle to be actuated in a targeted manner with a long lead time, which in particular increases convenience for a user of the motor vehicle.

The ultra-wideband transmission and receiving units of the positioning device can, in particular, be arranged symmetrically on the motor vehicle in relation to a central axis of the motor vehicle, for example in the region of a bumper of the motor vehicle and/or in the region of the A pillars of the motor vehicle and/or in the region of the B pillars of the motor vehicle and/or in the region of the C pillars of the motor vehicle. Further expediently, the positioning device is realized from six separate ultra-wideband transmission and receiving units. The ultra-wideband transmission and receiving units can further expediently be connected in a communicative manner to each other and expediently to the computing unit of the positioning device and to an access system, installed in the motor vehicle and discussed hereinbelow, for locking and unlocking and/or for actively opening a vehicle door of the motor vehicle.

Expediently, the at least one object is realized by an ultra-wideband communication-enabled mobile unit. In particular, it can be provided that the mobile unit is realized by a mobile end device, for example by a so-called intelligent key (smart key), a mobile telephone (smart phone), or a so-called CoD, i.e., a smart device in the possession of the user of the motor vehicle (consumer owned smart device). Therefore, an embodiment for the at least one object, which is convenient for the user of the motor vehicle and widely accepted, is specified.

To summarize, the following should be noted: the present invention expediently relates to an ultra-wideband positioning method for a positioning device arranged in a motor vehicle, with the steps: 1) establishing, by means of the positioning device, a bidirectional ultra-wideband data communication between the positioning device and at least one ultra-wideband communication-enabled object approaching the motor vehicle, wherein first positions and/or trajectories of the at least one object relative to the motor vehicle are determined by means of the positioning device using data packets exchanged in the context of the ultra-wideband data communication, and 2) performing an ultra-wideband positioning and distance measurement by means of the positioning device, wherein second positions and/or trajectories of the at least one object relative to the motor vehicle are determined by means of the positioning device by the positioning device emitting at least one ultra-wideband transmission signal and detecting the backscattered radio signals reflected back from at least one object with a time delay. The invention expediently further relates to a positioning device for performing said ultra-wideband positioning method and in particular to a motor vehicle having such a positioning device.

Further important features and advantages of the invention result from the dependent claims, the drawings and the associated figure description given with reference to the drawings.

It is understood that the aforementioned features and the features still to be explained in the following can not only be used in the respectively specified combination, but also in other combinations or in isolation, without leaving the scope of the present invention.

Preferred embodiments of the invention are presented in the drawings and are explained in more detail in the following description, wherein the same reference signs refer to identical or similar or functionally identical components.

### BRIEF DESCRIPTION OF THE DRAWING FIGURES

In the drawings:

FIG. 1 schematically shows in a plan view, a purely symbolically drawn motor vehicle having a positioning device for performing the ultra-wideband positioning method according to the invention, and

FIG. 2 schematically shows a flow chart of the ultra-wideband positioning method according to the invention.

### DETAILED DESCRIPTION

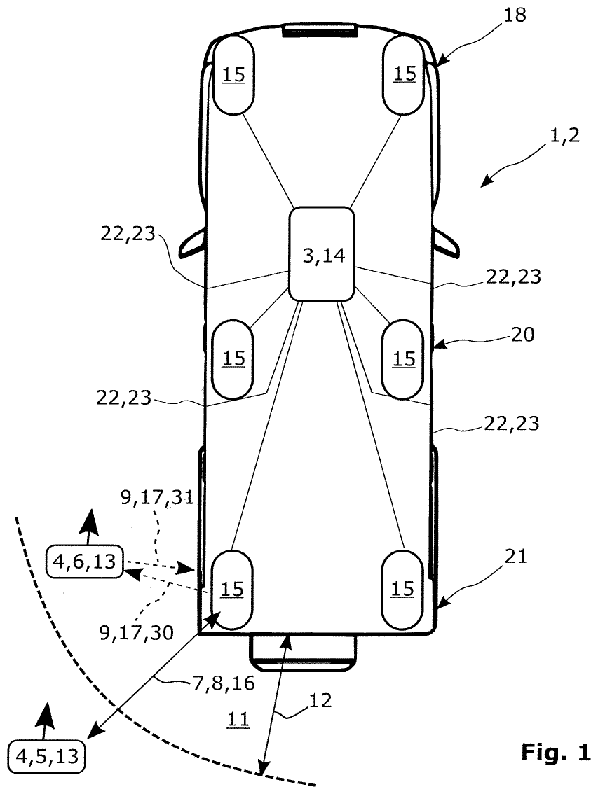

As explained, FIG. 1 shows a motor vehicle, referred to in its entirety with the reference number 2, in a plan view having a positioning device 3 set up to perform the ultra-wideband positioning method 1 according to the invention, which purely by way of example, has six separate ultra-wideband transmission and receiving units 15, indicated by boxes, a computing unit 14, indicated similarly by a box, and a computer-readable storage medium integrated into the computing unit 14 in this case. The ultra-wideband transmission and receiving units 15 are each fixed on the motor vehicle 2; by way of example, two of them are fixed symmetrically with regard to a center axis (not shown) of the motor vehicle 2 in the region of a front bumper 18 of the motor vehicle 2 and in the region of the B-pillars 20 of the motor vehicle 2 and in the region of the C-pillars 21 of the motor vehicle 2 or in the region of a rear bumper of the motor vehicle 2. The integrated storage medium includes instructions, which, when performed by the computing unit 14, cause the positioning device 3 to perform the ultra-wideband positioning method 1 described below. The motor vehicle 2 from FIG. 1 further has several vehicle doors 23 and an access system 22 for locking and unlocking and/or for actively opening the vehicle doors 23. The components of the positioning device 3 are connected in a communicative manner to the access system 22, so that this can be actuated in the context of the ultra-wideband positioning method 1 by means of the positioning device 3.

In the context of the two-step ultra-wideband positioning method 1, in order to determine first positions and trajectories 5 and/or second positions and trajectories 6 of a ultra-wideband communication-enabled object 4 approaching the motor vehicle 2, in the present case an ultra-wideband communication-enabled mobile unit 13, it is provided that initially a bidirectional ultra-wideband data communication 7 is established by means of the positioning device 3 between the positioning device 3, i.e., the ultra-wideband transmission and receiving units 15, and the at least one object 4 once the at least one object 4 is located inside a specified or specifiable communication range of the positioning device 3.

Once an ultra-wideband data communication 7 can be or has been established, first positions and trajectories 5 of the at least one object 4 relative to the motor vehicle 2 are determined by means of the computing unit 14 of the positioning device 3 using data packets 8 exchanged in the context of the ultra-wideband data communication 7 between the at least one object 4 and the positioning device 3. For example, to determine the first positions and trajectories 5, the data packets 8 exchanged here can be evaluated by means of a transit time measurement, referred to as a TOF (time of flight), by measuring the transit times of such data packets 8 between the at least one object 4 and the ultra-wideband transmission and receiving units 15 of the positioning device 3. Additionally, or alternatively, the first positions and trajectories 5 can be furthermore evaluated by means of triangulation. As a result, initially relatively rough first positions and trajectories 5 of the at least one object 4 are determined in the context of the established ultra-wideband data communication 7 in the context of the ultra-wideband positioning method 1, i.e., a rough positioning is realized.

Following this, once the at least one object 4 falls below a specified or specifiable distance 12 between itself and the motor vehicle 2, which describes an approach zone 11 that surrounds the motor vehicle 2, an ultra-wideband positioning and distance measurement 9 is performed by means of the positioning device 3, i.e., by means of the ultra-wideband transmission and receiving units 15, which could also be referred to as an ultra-wideband radio radar. In this case, initially at least one ultra-wideband transmission radio signal 30 is emitted by means of the positioning device 3, i.e., by means of the ultra-wideband transmission and receiving units 15, and then its backscattered radio signals 31 reflected back from the at least one object 4 are detected with a time delay. In this case, second positions and trajectories 6 of the at least one object 4 relative to the motor vehicle 2 are determined by means of the computing unit 14 of the positioning device 3. As a result, relatively accurate second positions and trajectories 6 of the at least one object 4 are determined in the context of the performed ultra-wideband positioning and distance measurement 9 (ultra-wideband radio radar), so that one can also speak of pinpointing the at least one object 4. Using the determined first positions and trajectories 5 and/or second positions and trajectories 6, a vehicle door 23 of the motor vehicle 2 and/or other system functions of the motor vehicle 2, for example, can then be activated in a targeted manner with a long lead time, whereby in particular the convenience for a user of the motor vehicle 2 is increased.

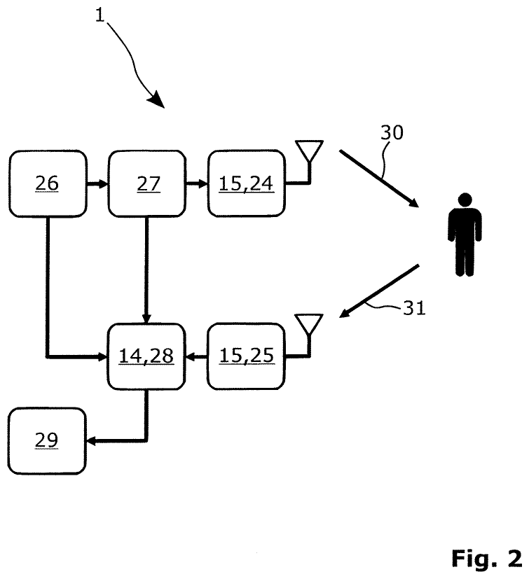

To be able to use the ultra-wideband transmission and receiving units 15 of the positioning device 3 both for establishing and maintaining an ultra-wideband data communication 7 and for performing an ultra-wideband positioning and distance measurement 9 (ultra-wideband radio radar), it is provided that the ultra-wideband transmission and receiving units 15 are each set up to be operated in a first operating mode 16, in which a bidirectional ultra-wideband data communication 7 is or can be established, and in a second operating mode 17, in which an ultra-wideband positioning and distance measurement 9 is or can be performed. In particular, it can be provided that the ultra-wideband transmission and receiving units 15 are operated in pulsed mode in the second operating mode 17 (ultra-wideband radio radar). The ultra-wideband transmission and receiving units 15 are for this purpose, by way of example, each equipped with a transmission device 24, set up to emit pulsed ultra-wideband transmission radio signals 30, and a receiving device 25, set up to receive pulsed backscattered radio signals 31; see FIG. 2.

In order to illustrate this, a flow chart of the ultra-wideband positioning method 1 according to the invention is presented in FIG. 2, wherein an ultra-wideband transmission and receiving unit 15 consisting of a transmission device 24 and a receiving device 25, each indicated by boxes, is illustrated by way of example. The transmission device 24 is supplied with an electrical control signal by an internal system clock 26 and a pulse wave generator 27, so that it can emit a pulse ultra-wideband transmission radio signal 30, symbolized by an arrow, which is reflected back from a mobile unit 13 as a pulse backscattered radio signal 31 with a time delay, so that it is detected at the receiving device 25 and can be provided by way of example to a wave delay recognition unit 28 of the positioning device 3. Subsequently, the wave delay recognition unit 28 can carry out an evaluation of the received pulse backscattered signal 31 and in particular provide a second position and trajectories 6 at a user interface 29. Expediently, the wave delay recognition unit 28 is an integral component of the computing unit 14 or forms the same.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-14. (canceled)

15. A ultra-wideband positioning method for a positioning device arranged in a motor vehicle, the ultra-wide position method comprising:
establishing, by the positioning device, a bidirectional ultra-wideband data communication between the positioning device and at least one ultra-wideband communication-enabled object approaching the motor vehicle;
determining, by the positioning device using data packets exchanged using the bidirectional ultra-wideband data communication, first positions and first trajectories of the at least one object relative to the motor vehicle;
subsequently performing, by the positioning device, an ultra-wideband positioning and distance measurement; and
determining, by the positioning device emitting at least one ultra-wideband transmission signal and detecting backscattered radio signals reflected back from the at least one object with a time delay, second positions and second trajectories of the at least one object relative to the motor vehicle,
wherein the second positions and second trajectories of the at least one object relative to the motor vehicle are determined once the at least one object falls below a predetermined distance between the at least one object and the motor vehicle, wherein the predetermined distance is an approach zone surrounding the motor vehicle,
wherein the positioning device determines the first trajectories using the first positions and determines the second trajectories using the second positions,
wherein the first trajectories and the second trajectories are determined by a computing unit of the positioning device, and
wherein future first positions are determined from the first trajectories and future second positions are determined from the second trajectories.

16. The ultra-wideband positioning method of claim 15, wherein the method is performed in two ultra-wideband steps using the positioning device to first establish the ultra-wideband data communication and then subsequently performing an ultra-wideband positioning and distance measurement.

17. The ultra-wideband positioning method of claim 15, wherein the ultra-wideband data communication is established between the positioning device and the at least one object once the at least one object is located inside a predetermined communication range of the positioning device.

18. The ultra-wideband positioning method of claim 15, wherein, to determine the first positions and first trajectories of the at least one object relative to the motor vehicle, data packets exchanged in the ultra-wideband data communication are evaluated using a transit time measurement in which transit times of the exchanged data packets between the at least one object and the positioning device are determined.

19. The ultra-wideband positioning method of claim 15, wherein to determine the first positions and first trajectories of the at least one object relative to the motor vehicle, data packets exchanged in the ultra-wideband data communication are evaluated by triangulation.

20. The ultra-wideband positioning method of claim 15, wherein the at least one object is an ultra-wideband communication-enabled mobile unit.

21. The ultra-wideband positioning method of claim 15, wherein computing unit of the positioning device determines the first positions and first trajectories of the at least one object and the second positions and second trajectories of the at least one object.

22. The ultra-wideband positioning method of claim 15, wherein the positioning device includes ultra-wideband transmission and receiving units installed in the motor vehicle, wherein the ultra-wideband transmission and receiving units are respectively configured to be operated in a first operating mode in which the bidirectional ultra-wideband data communication is or can be established, and in a second operating mode in which the ultra-wideband positioning and distance measurement is or can be performed.

23. The ultra-wideband positioning method of claim 22, wherein
the ultra-wideband transmission and receiving units are each operated either in the first operating mode or in the second operating mode depending on the determined first positions or the determined second positions of the at least one object,
all of the ultra-wideband transmission and receiving units are operated simultaneously or at least one ultra-wideband transmission and receiving unit is operated at a beginning of the ultra-wideband positioning method in the first operating mode,
all of the ultra-wideband transmission and receiving units are operated simultaneously or at least one ultra-wideband transmission and receiving unit of the ultra-wideband transmission and receiving units is operated in the first operating mode when an ultra-wideband data communication is or can be established between the respective ultra-wideband transmission and receiving unit and the at least one object located in a specified or specifiable communication range of the positioning device, or
at least one ultra-wideband transmission and receiving unit of the ultra-wideband transmission and receiving units is operated in the second operating mode when at least one object falls below a predetermined distance between the at least one ultra-wideband transmission and receiving unit and the at least one object, which is the approach zone surrounding the motor vehicle.

24. The ultra-wideband positioning method of claim 15, wherein the positioning device or at least one ultra-wideband transmission and receiving unit of the positioning device is operated in pulsed mode.

25. The ultra-wideband positioning method of claim 15, wherein the motor vehicle includes an access system communicatively connected to the positioning device and configured to be actuated, by the positioning device, to lock, unlock, or actively open a vehicle door of the motor vehicle by depending on the determined first positions and first trajectories of the at least one object or depending on the determined second positions and second trajectories of the at least one object.

26. A positioning device comprising:
at least one ultra-wideband transmission and receiving unit configured to emit and receive ultra-wideband radio signals;
a computing unit configured to perform computing operations; and
a computer-readable storage medium comprising instructions, which, when executed by the computing unit, cause the positioning device to
establish a bidirectional ultra-wideband data communication between the positioning device and at least one ultra-wideband communication-enabled object approaching the motor vehicle;
determine, using data packets exchanged using the bidirectional ultra-wideband data communication, first positions and first trajectories of the at least one object relative to the motor vehicle;
subsequently perform an ultra-wideband positioning and distance measurement; and
determine, by the positioning device emitting at least one ultra-wideband transmission signal and detecting backscattered radio signals reflected back from the at least one object with a time delay, second positions and second trajectories of the at least one object relative to the motor vehicle,
wherein the second positions and second trajectories of the at least one object relative to the motor vehicle are determined once the at least one object falls below a predetermined distance between the at least one object and the motor vehicle, wherein the predetermined distance is an approach zone surrounding the motor vehicle,
wherein the positioning device determines the first trajectories using the first positions and determines the second trajectories using the second positions,
wherein the first trajectories and the second trajectories are determined by a computing unit of the positioning device, and
wherein future first positions are determined from the first trajectories and future second positions are determined from the second trajectories.

27. The positioning device of claim 26, wherein the at least one ultra-wideband transmission and receiving unit has a transmission device and a receiving device.

28. A motor vehicle comprising:
a positioning device comprising
at least one ultra-wideband transmission and receiving unit configured to emit and receive ultra-wideband radio signals;
a computing unit configured to perform computing operations; and
a computer-readable storage medium comprising instructions, which, when executed by the computing unit, cause the positioning device to
establish a bidirectional ultra-wideband data communication between the positioning device and at least one ultra-wideband communication-enabled object approaching the motor vehicle;
determine, using data packets exchanged using the bidirectional ultra-wideband data communication, first positions and first trajectories of the at least one object relative to the motor vehicle;
subsequently perform an ultra-wideband positioning and distance measurement; and
determine, by the positioning device emitting at least one ultra-wideband transmission signal and detecting backscattered radio signals reflected back from the at least one object with a time delay, second positions and second trajectories of the at least one object relative to the motor vehicle,
wherein the second positions and second trajectories of the at least one object relative to the motor vehicle are determined once the at least one object falls below a predetermined distance between the at least one object and the motor vehicle, wherein the predetermined distance is an approach zone surrounding the motor vehicle,
wherein the positioning device determines the first trajectories using the first positions and determines the second trajectories using the second positions,
wherein the first trajectories and the second trajectories are determined by a computing unit of the positioning device, and
wherein future first positions are determined from the first trajectories and future second positions are determined from the second trajectories;
an access system configured to lock, unlock, or actively open a vehicle door of the motor vehicle,
wherein the positioning device is communicatively connected to the access system in and is configured to actuate the access system depending on the determined first positions and first trajectories of the at least one objector the determined second positions and second trajectories of the at least one object.
